(19) United States
(12) Patent Application Publication
(10) Pub. No.: US 2022/0147030 A1
(43) Pub. Date: May 12, 2022

(54) Method for Controlling a Production Process for Producing Components

(71) Applicant: GKN Sinter Metals Engineering GmbH, Radevormwald (DE)

(72) Inventor: Peter Oberparleiter, Bruneck (IT)

(21) Appl. No.: 17/438,862

(22) PCT Filed: Mar. 13, 2020
(86) PCT No.: PCT/EP2020/056906

§ 371 Date: Sep. 13, 2021

(30) Foreign Application Priority Data
Mar. 14, 2019 (EP) 19162798.3

(51) Int. Cl. G05B 19/418

(52) U.S. Cl. CPC G05B 19/41865; G05B 2219/32199

(57) ABSTRACT

Method for controlling a production process for producing components, wherein the components or a manufacturing device used to produce the components has/have at least one first feature which can be captured using metrology; at least having the following steps: a) determining a test plan for capturing the first feature with a first value of a first test frequency, wherein at least one first stability criterion is defined for the first feature; b) producing the components and carrying out the test plan in a parallel manner, wherein the first feature is tested at the first test frequency; c) evaluating the test results; d) changing the first test frequency, wherein the first test frequency is increased if at least one test result for the first feature violates the first stability criterion; wherein the first test frequency is reduced if all test results are in accordance with the first stability criterion.

The present invention relates to a method for controlling a production process for producing components.

During the production of mass-produced components, various quality and process measurements are regularly carried out. These measurements are generally carried out as random sampling. For example, a particular feature (for example a weight of a component produced by sintering technology) may be detected at regular time intervals respectively on a particular number of components. Further measurements relate for example to other features of the component, for example a length, a density, a parallelism of surfaces or a diameter of the component. As an alternative thereto or in addition, process parameters, for instance the pressure profile at a machine during the pressing process for producing so-called green compacts, may also be detected at time intervals.

By purely statistical establishment of test intervals, the continuously changing risks that arise in a real process are not taken into account. In the case of stable processes in which components are produced with a constantly high quality, too many measurements are therefore usually carried out. Avoidable costs are thereby entailed. In the case of unstable processes, on the other hand, there is the risk that errors will not be identified adequately because of an insufficient number of measurements.

On the basis thereof, it is an object of the present invention at least to alleviate, or even to resolve, the problems explained in relation to the prior art. In particular, the intention is to provide a method for controlling a production process for producing components, in which a testing outlay is managed as a function of a stability of the production process.

In order to achieve these objects, a method according to the features of claim 1 is proposed. The dependent claims relate to advantageous embodiments. The individual features referred to in the claims may be combined with one another in a technologically expedient way and may be supplemented with explanatory technical content from the description, with further alternative embodiments of the invention being presented.

A method for controlling a production process for producing components is proposed. In this method, the components or a manufacturing device have at least one metrologically detectable first feature (for example a volume, a weight, a density, a parallelism of surfaces or a diameter of the component; a temperature, a pressure, a power consumption of the manufacturing device). The method comprises at least the following steps:

a) establishing a test plan for detecting the first feature with a first value of a first test frequency (for example in units of [one test per number of components] or [one test per period of time of the production process]); at least one first stability criterion being defined for the first feature;
b) producing the components and in parallel carrying out the test plan, the first feature being tested at the first test frequency;
c) evaluating the test results (determined at least in a defined period of time or over a defined number of tested components);
d) varying the first test frequency,

(either) the first test frequency being increased if at least one test result for the first feature violates the first stability criterion;

(or) the first test frequency being decreased if all test results are in compliance with the first stability criterion.

A production process comprises the production of a component, for example the production of a component by sintering technology. In this case, for example, a material in powder form is provided, pressed to form a green compact and subsequently treated by sintering technology (that is to say thermally). Machining may optionally be carried out. In the scope of the production process, in particular a multiplicity (for example at least 100, 1000 or several tens of thousand) of mutually ideally identical components are produced.

As a (first) feature to be detected, for example a weight of a component produced by sintering technology, or for example a length, a density, a parallelism of surfaces or a diameter of the component, may be detected. Furthermore, a burr or an appearance of a surface of the component, for example matt or glossy, etc., may also be defined as the feature. A feature of a manufacturing device, for example an applied pressure or a power consumption, may likewise be detected.

The first value of the first test frequency may, for example, represent an initial value for a newly started process of producing the component or components. This value may, for example, comprise a test on one component per 1000 components or testing of a random sample of a plurality of components (for example on five directly consecutively produced components) per 1000 components, or the like. As an alternative or at the same time, the first test frequency may be established as a function of a period of time of the production process. Then, for example, a feature of a manufacturing device may be detected or a test may be carried out (on one or more components) every hour of the production process. Optionally, the number of components that have been produced in the period of time, or have undergone an established processing step, may in this case be taken into account.

The test results may be determined from the assessment of respectively only a single value, or respectively a plurality of values. The evaluation or assessment of a plurality of values may be based on mathematical methods, for example averaging and/or the standard deviation within a random sample.

A stability criterion may be established as a defined deviation from a setpoint value for the first feature. In this case, the stability criterion need not in particular correspond to an allowed tolerance for the setpoint value. In particular, the tolerance is defined widely than the stability criterion. Accordingly, a component would not necessarily be defective if the first feature violates the stability criterion (and therefore may still lie within the tolerance).

In particular, a violation of the stability criterion may also depend on a method with which, for example, a random sample of components that has been checked during sampling is evaluated.

For example, a number may be defined as a subset of the components of a random sample (the random sample comprises, for example, five components), beyond which violation of the stability criterion is identified. There must thus be a minimum number of components of a random sample (that is to say for example at least two components out of the random sample of five components), which for example have a minimum deviation from a nominal value of the first feature, violation of the stability criterion only then being identified.

By means of the violation of the stability criterion, a process instability may in particular be identified, so that possible impending non-compliance with the tolerance may be prevented by corrective intervention in the production process.

In particular, the production of the components and the conduct of the test plan, that is to say the conduct of measurements of the first feature, may be carried out chronologically in parallel with one another.

According to step c), the evaluation of the test results, that is to say of the measurements of at least the first feature, is carried out.

According to step d), the first test frequency (which is assigned to the first feature) is varied, that is to say the first value of the first test frequency is adjusted to a different second value of the first test frequency. In this case, the first test frequency is increased if, for example, at least one test result for the first feature violates the first stability criterion. On the other hand, the first test frequency is decreased if all test results are in compliance with the first stability criterion.

Here, it is thus proposed that when the production process is running stably (and the test results at least for the first feature do not have a sizeable deviation, that is to say test results are in compliance with the stability criterion), the first test frequency may be reduced.

If a possible instability of the production process is identified (i.e. for example at least one test result at least for the first feature has a sizeable deviation, that is to say the test result violates the stability criterion), the first test frequency may be increased.

In industrial mass production, statistical measurement methods (SPC; statistical process control) are applied in order to assess the stability of the production process of components. To this end a comprehensive test plan, which permanently establishes the test frequency for all relevant quality and process features, is generated. With the approach proposed here, dynamization of the test frequencies is proposed. To this end, the test frequency for a feature may be adapted constantly on the basis of the stability of the production process. For stable production processes, the test frequency is progressively reduced so long as predefined stability criteria are complied with.

The person skilled in the art will for example use a so-called intervention limit, a tolerance limit, or a stability limit for the definition of a stability criterion. Thus, if the test results of the feature to be tested lie within the defined limits, the test frequency is successively reduced.

In the converse case, the test frequency is increased as soon as the test results of the feature can be tested lie outside defined limits, since this limit crossing shows a higher quality risk for the component.

Under stable conditions of the production process, measurements of features to be tested may therefore be reduced to a minimum while a high quality of the components produced is nevertheless ensured.

In particular on the basis of computer-assisted measurement value detection and measurement value registering, test results may be analyzed constantly and assessed as to whether the production process is stable or whether interventions in the production process are necessary.

On the basis of the measurements carried out and the test results obtained therefrom, it is possible in particular to detect a trend in the variation of a feature (for example a weight or height). If the test results lie within defined limit values (satisfy the stability criterion) over a defined period of time or over a particular number of random samples, it may be deduced therefrom that the process is running stably for the tested feature in question and the test frequency may therefore be reduced. This reduction may also be carried out in stages, and in the ideal case the test frequency may be set to a defined minimum.

If one or more test results violate at least one stability criterion during a test, however, this indicates an unstable production process and the test frequency is increased, and the production process is therefore monitored more closely. In parallel, an intervention in the production process may be carried out in order to restore the process stability, including the rejection of components suspected to be defective. The higher test frequency ensures that the production process is monitored more closely for a defined period of time. Only when the test results satisfy the at least one stability criterion over a defined period of time or over a particular number of random samples, or components, may be test frequency be reduced again in stages.

The status of an individual feature of the component may, for example, be monitored in a process step on the basis of the test frequency defined in the test plan. If the test result is within predefined limits for a predefined time, or number of random samples, the test frequency in the first step may for example be halved, that is to say for example to 50% of a value previously complied with for a test frequency. If the at least one stability criterion is violated, the test frequency of the feature in the first step may, for example, be set to two times the current test plan specification, that is to say for example to 200% of a value previously complied with for the test frequency. If the test results of this feature subsequently satisfy the at least one predefined stability criterion for a predefined time, or number of random samples, the test frequency may be changed in stages to the standard specification (that is to say the original value of the test frequency) and later in turn to half the value of the test plan specification. If test results continue to violate the at least one stability criterion, however, the doubled test frequency is maintained or even increased to 100% testing (that is to say of each component, or continual process parameter detection).

In particular, it is possible to remove components as a function of the test results and, for example, send them for reprocessing or optionally declare them as rejects.

In a first step, three states may therefore arise for the test frequency:
(1) Reduced test frequency: the testing is carried out, for example, with half the test frequency compared with a test plan specification;
(2) Standard test frequency: the testing is (still) carried out with the test frequency according to the test plan specification;
(3) Enhanced test frequency: the testing is carried out, for example, with two times the test frequency compared with the test plan specification.

In particular, the decrease or increase of the test frequency is carried out in stages to respectively defined values of the first test frequency, that is to say for example to respectively at least 130% or at most 70% of a previous value of the test frequency.

In particular, the increase of the first test frequency is carried out in larger stages than the decrease of the first test frequency. In particular, the first test frequency is adjusted to a value higher than the original first value regardless of a currently existing test frequency (if the latter is lower than the original first value).

Preferably, the decrease of the first test frequency is carried out in larger stages than the increase of the first test frequency.

In particular, the decrease or increase is carried out in mutually different (that is to say in different stages for a decrease than for an increase) and varying stages (that is to say respectively in stages that are then larger or smaller for a further decrease or further increase).

A variation of the test frequency, for example the doubling or halving of the test frequency, may in particular be applied to further or all metrologically detectable features, intended by the test plan for metrological detection, of the component or of the manufacturing device (optionally only features that are present in an identical process step of the production process). In particular, it may in this case be assumed that the test features are mutually independent, and the test frequency is therefore adapted merely on the basis of the previously determined data of the respective test feature.

A variation of the test frequency, for example the doubling or halving of the test frequency, may in particular be applied to further or all test features, and optionally other or all process steps of the production process.

In particular, 100% testing (that is to say testing of each component) is carried out at the start of a production process and the test frequency is then successively reduced if the requirements are satisfied.

In particular, the production of the component comprises a multiplicity of process steps, the first feature being present, and being tested, after a first process step, and (a metrologically detectable) second feature being present after a second process step chronologically following the first process step.

On the basis of the test results, the test frequency may be reduced successively if the respective test results of the feature satisfy the at least one stability criterion for long enough. The reduction of the test frequency may be carried out not only once but several times, optionally in stages, as far as a defined minimum.

If the at least one stability criterion is violated (that is to say for example at least one test result lies for example outside an intervention limit), the test frequency for the feature may be increased, for example set to two times the value of the test plan specification (that is to say the original value of the test frequency), and an intervention may optionally be carried out in the production process in order to restore the stability of the production process. If the test results of this feature subsequently satisfy the at least one predefined stability criterion for a defined time, or number of random samples, the test frequency may be reduced again, for example set to the standard specification according to the test plan (that is to say to the original value), and subsequently in turn reduced successively. If test results continue to violate the at least one stability criterion, however, an increased, that is to say optionally for example doubled, test frequency may be maintained.

In particular, the decrease of the test frequency takes place only to a defined minimum of a test frequency, which is not equal to zero.

In particular, the test frequency is not successively halved or doubled, but instead the degree of change is established for each feature tested, or to be tested, and each process step of the production process individually on the basis of the stability of the production process, and optionally the particular importance of the feature. A fully variably modulable test interval may be developed therefrom.

For the dynamization of test frequencies, historical measurement data of previous production tasks may be used. The dynamic adaptation of the test frequency (increase or decrease) may therefore already be carried out, or initiated, at the start of the task, if the historical measurement data imply dynamization or suggest that it is expedient.

In particular, between such different (that is to say previous or other) production processes or production tasks, there are time intervals in which, for example, upgrading of the tools for producing the component has been carried out or in which other components have been produced.

An apparatus for data processing is furthermore proposed, comprising a processor which is configured in such a way that it carries out the described method.

As a precaution, it should be pointed out that the numerals employed here (“first”, “second”, “third”, . . . ) are used primarily (only) to distinguish between a plurality of objects, quantities or processes of the same type, that is to say in particular they do not necessarily specify any dependency and/or order of these objects, quantities or processes with respect to one another. If a dependency and/or order is required, it is explicitly indicated here or is readily apparent to the person skilled in the art on studying the configuration specifically described.

1. A method for controlling a production process for producing components, wherein the components or a manufacturing device used for producing the components have at least one metrologically detectable first feature, the method having at least the following steps:
a) establishing a test plan for detecting the first feature with a first value of a first test frequency, at least one first stability criterion being defined for the first feature;
b) producing the components and in parallel carrying out the test plan, the first feature being tested at the first test frequency;
c) evaluating the test results determined;
d) varying the first test frequency, the first test frequency being increased if at least one test result for the first feature violates the first stability criterion, the first test frequency being decreased if all test results are in compliance with the first stability criterion.

2. The method as claimed in claim 1, wherein in step d) the increase of the first test frequency is carried out to at least 130% of the first value and the decrease of the test frequency is carried out to at most 70% of the first value.

3. The method as claimed in claim 1, wherein the decrease or increase of the test frequency is carried out in stages to respectively defined values of the first test frequency.

4. The method as claimed in claim 3, wherein the increase of the first test frequency is carried out in larger or smaller stages than the decrease of the first test frequency.

5. The method as claimed in claim 1, wherein the decrease or increase is carried out in mutually different and varying stages.

6. The method as claimed in claim 1, wherein the first test frequency can be increased up to 100% testing, that is to say testing of each component or continual process parameter detection.

7. The method as claimed in claim 1, wherein the production of the component comprises a multiplicity of process steps;
wherein the first feature is provided and tested after a first process step; wherein a metrologically detectable second feature is provided after a second process step chronologically following the first process step.

8. The method as claimed in claim 1, wherein the decrease of the test frequency is carried out only as far as a defined minimum of a test frequency, which is not equal to zero.

9. An apparatus for data processing, comprising a processor which is configured in such a way that it carries out the method as claimed in claim 1.
